(19) United States
(12) Patent Application Publication
(10) Pub. No.: US 2004/0045416 A1
(43) Pub. Date: Mar. 11, 2004

(54) Hand tool

(76) Inventor: Mou-Tang Liou, Nantou City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/652,821

(22) Filed: Aug. 29, 2003

Related U.S. Application Data
(63) Continuation-in-part of application No. 09/941,991, filed on Aug. 29, 2001, now Pat. No. 6,612,586.

(51) Int. Cl. B25B 23/16

(52) U.S. Cl. 81/177.1

(57) ABSTRACT

A tool includes a handle, a bit and a locking device. The handle includes a socket defining a first tunnel, a second tunnel and at least one aperture through which the first tunnel is communicated with the second tunnel. The bit includes a working head formed at an end, a shank formed at an opposite end and a series of recesses defined in the shank. The shank can be inserted in the first tunnel. The locking device includes at least one ball detent and a latch. The at least one ball detent is put in the aperture. The latch extends in the second tunnel for pushing the ball detent into one of the recesses in a locking position and defining at least one notch for receiving the ball detent in a releasing position.

### CROSS-REFERENCE

The present application is a continuation-in-part application of U.S. patent application Ser. No. 09/941991.

### BACKGROUND OF INVENTION

1. Field of Invention

The present invention is related to a hand tool and more particularly to a hand tool including a handle and a bit engaged with the handle.

2. Related Prior Art

U.S. Pat. No. 5,934,384 discloses a conventional drill that includes a transmission shaft 1, a stop member 2, a C-clip 3, a compression spring 4, a locating ring 5, a chuck 6 and a bit 8. The transmission shaft 1 includes a coupling hole 10 defined in an end for receiving the bit 8 and a coupling rod 13 extending from an opposite end for engagement with a motor. In the periphery of the transmission shaft 1 is defined a locating groove 11. The transmission shaft 1 defines a through hole 110 through which the coupling hole 10 is communicated with the locating groove 11. The stop member 2 includes an arched body and a rod 20 extending from a midpoint of the arched body. The arched body of the stop member 2 is put in the locating groove 11 while the rod 20 is inserted in the through hole 110. In the periphery of the transmission shaft 1 is defined an annular groove 12 for receiving the C-clip 3. The compression spring 4 is mounted on the transmission shaft 1. The chuck 6 defines a central through hole 60 that includes a tapered orifice 61. The chuck 6 is mounted on the transmission shaft 1 so as to enclose the stop member 2, the C-clip 3 and the compression spring 4. The locating ring 5 is fit in the chuck 6. The compression spring 4 is compressed between the C-clip 3 and the locating ring 5. The tapered orifice 61 pushes the arched body of the stop member 2 so as to insert the rod 20 into the coupling hole 10. The bit 8 includes a shank 80 including several angles 81 in each of which a cut 82 is defined for receiving the rod 20. The chuck 6 is pulled from the transmission shaft 1 so as to move the tapered orifice 61 from the arched body of the stop member 2. Thus, the rod 20 leaves the coupling hole 10. Hence, the shank 80 of the bit 8 can be inserted into or pulled from the coupling hole 10. However, such pulling requires delicate actions of a hand, i.e., holding the transmission shaft 1 with the palm and four fingers and pushing the chuck 6 with the thumb. Moreover, a distance taken from the bit 8 to the coupling rod 13 is not adjustable for only one cut 82 is defined in each of the angles 81 of the periphery 80 of the bit 8.

There have been devised various hand tools that each include a bit engaged with a handle in a releasable manner. Generally, such a bit includes an insert, and such a handle includes a socket for receiving the insert. A locking device is used to lock the insert in the socket.

The present invention is hence intended to obviate or at least alleviate the problems encountered in prior art.

### SUMMARY OF INVENTION

It is an objective of the present invention to provide a tool including a handle and a bit that can easily be engaged with and disengaged from the handle.

It is another objective of the present invention to provide a tool including a handle and a bit that can be engaged with the handle in various positions.

According to the present invention, a tool includes a handle, a bit and a locking device. The handle includes a socket defining a first tunnel, a second tunnel and at least one aperture through which the first tunnel is communicated with the second tunnel. The bit includes a working head formed at an end, a shank formed at an opposite end and a series of recesses defined in the shank. The shank can be inserted in the first tunnel. The locking device includes at least one ball detent and a latch. The at least one ball detent is put in the aperture. The latch extends in the second tunnel for pushing the ball detent into one of the recesses in a locking position and defining at least one notch for receiving the ball detent in a releasing position.

Other objects, advantages, and novel features of the invention will become more apparent from the following detailed description when taken in conjunction with the attached drawings.

### BRIEF DESCRIPTION OF DRAWINGS

The present invention will be described through detailed illustration of two embodiments referring to the attached drawings wherein:

FIG. 1 is a perspective view of a tool including a handle and a bit engaged with the handle according to a first embodiment of the present invention.

FIG. 2 is an exploded view of the tool of FIG. 1.

FIG. 3 is a cross-sectional view of the tool of FIG. 1.

FIG. 4 is similar to FIG. 3, but showing the handle in a releasing position for the bit.

FIG. 5 is similar to FIG. 4, but showing the handle in a locking position for the bit.

FIG. 6 is a cross-sectional view of a tool including a handle and a bit engaged with the handle according to a second embodiment of the present invention.

### DETAILED DESCRIPTION OF EMBODIMENTS

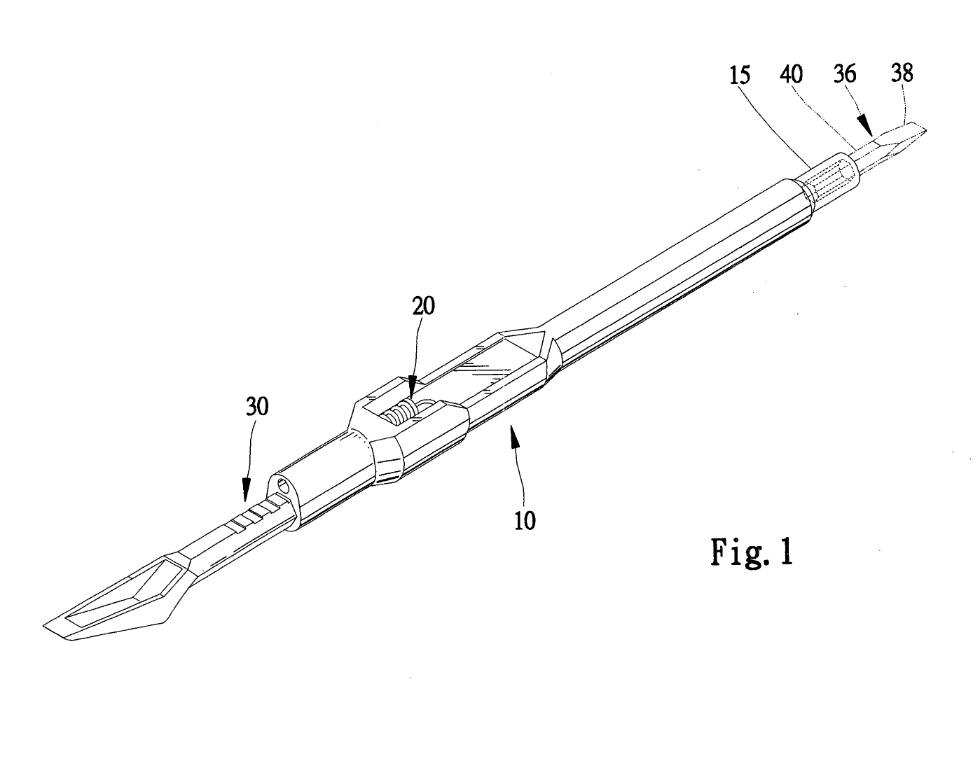

Referring to FIG. 1, according to a first embodiment of the present invention, a tool includes a handle 10, a bit 30 and a locking device 20 for locking the bit 30 to the handle 10. The bit 30 may be a crow.

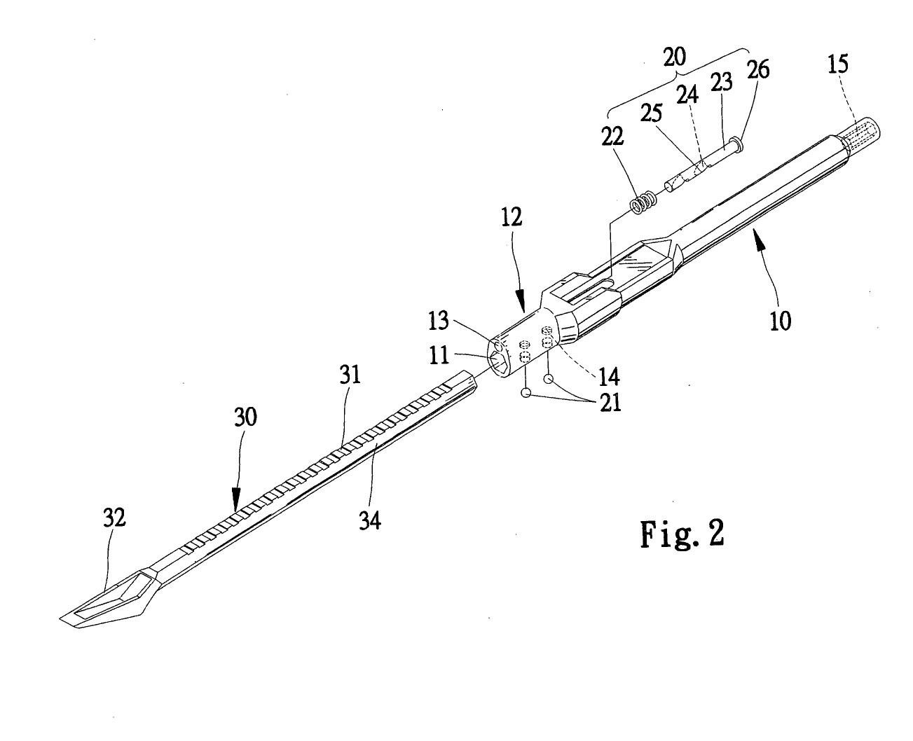

Referring to FIG. 2, the bit 30 includes a prying head 32 and a shank 34 for engagement with the handle 10. The shank 34 includes a series of recesses 31 defined therein.

The handle 10 includes a socket 12 formed at an end. The socket 12 defines a first tunnel 11, a second tunnel 13 extending in parallel with the first tunnel 11 and two apertures 14 through which the first tunnel 11 is communicated with the second tunnel 13. As known in the art, the first tunnel 11 is shaped corresponding to the shank 34 so as to receive the shank 34 non-rotationally. Each of the apertures 14 includes a first end at the first tunnel 11 and a second end at the second tunnel 13. The first end is smaller than the second end.

The locking device 20 includes two ball detents 21, a latch 23 and a spring 22. The latch 23 includes an end inserted in the second tunnel 13 and an opposite end formed with a button 26. Two notches 24 are defined in the latch 23. Each of the notches 24 includes a slope 25.

In assembly, the latch 23 is inserted through the spring 22 into the second tunnel 13 so that the apertures 14 are aligned with the notches 24. Each of the ball detents 28 is forced into one of the apertures 14 through the first end. Thus, each of the ball detents 21 is trapped in one of the apertures 14 and one of the notches 24.

As inserted into the first tunnel 11, the shank 34 pushes the ball detents 21 completely from the first channel 11. In turn, the ball detents 21 push of the slopes 25, thus causing the latch 23 to move.

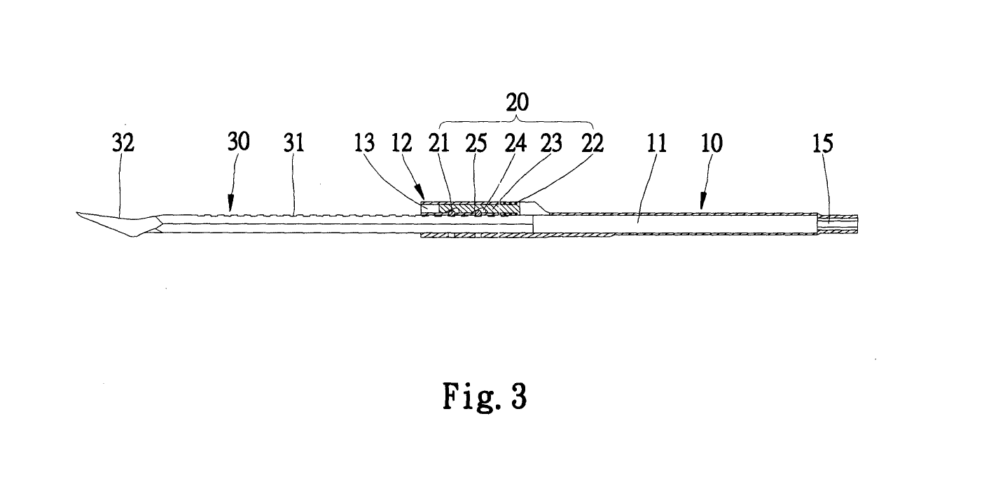

Referring to FIG. 3, the shank 34 is inserted in the socket 12. Two of the recesses 31 are aligned with the apertures 14 so as to receive the ball detents 21 pushed by means of the slopes 25. The latch 23 is kept in this position by means of the spring 22 compressed between the socket 12 and the button 26.

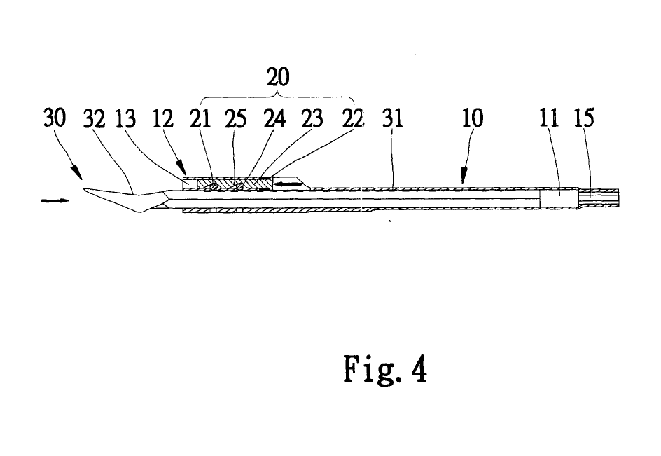

Referring to FIG. 4, the button 26 is pressed so that the slopes 25 are moved from the ball detents 21. Thus, the ball detents 21 can move further into the notches 24. That is, the ball detents 21 can completely escape the notches 31. Therefore, the shank 34 can be inserted further into the first tunnel 11. Although not shown, the shank 34 can be pulled from the first tunnel 11 as the button 26 is pressed.

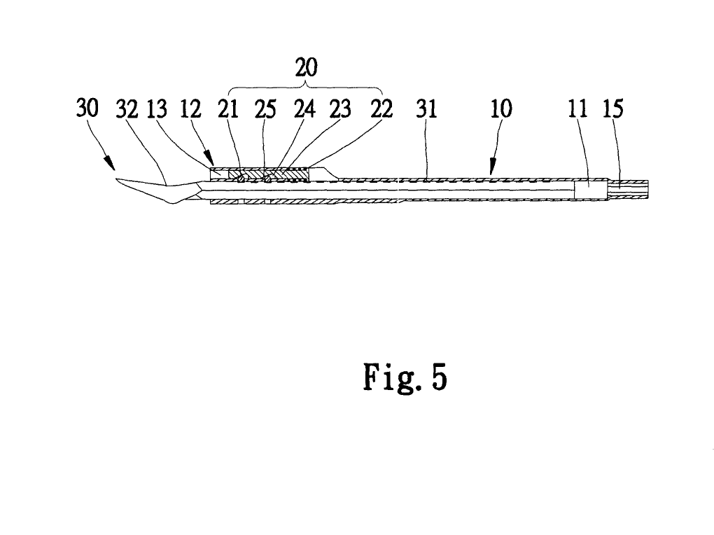

Referring to FIG. 5, the button 26 is released again. The bit 30 is locked to the handle 10 in a different position than the position shown in FIG. 3.

The tool may include an additional bit 36. The additional bit 36 may be a screwdriver. The additional bit 36 includes a screw-driving head 38 and a shank 40. In this case, the handle 10 includes a socket 15 formed at an opposite end for receiving the shank 40.

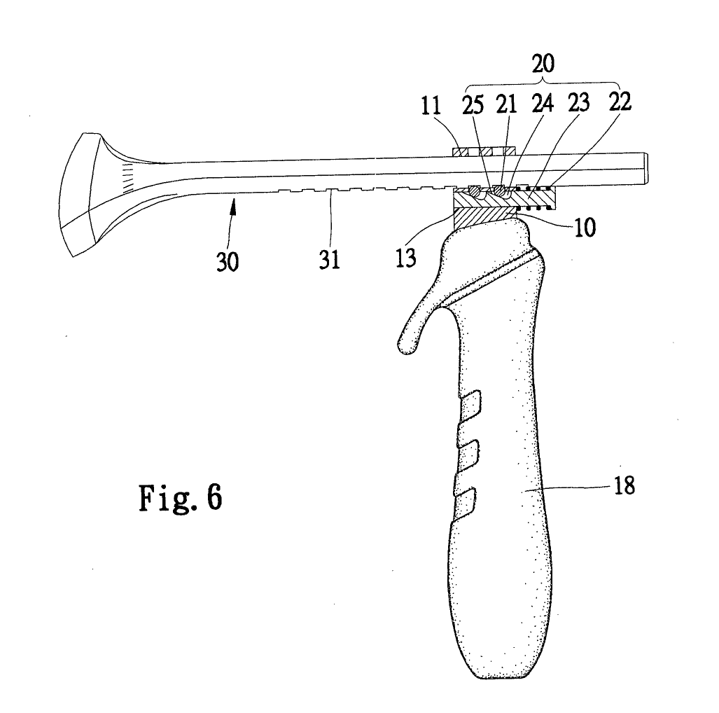

FIG. 6 shows a tool according to a second embodiment of the present invention. The second embodiment is identical to the first embodiment except for three points. Firstly, a chisel 30 is used instead of the bit 30. Secondly, the first tunnel 11 and the second tunnel 13 extend perpendicular to the handle 10. Thirdly, a grip 18 is formed on the handle 10.

Two embodiments of the present invention have been described in detail for illustration of the present invention. Those skilled in the art can derive variations from these embodiments. Hence, these embodiments shall not limit the scope of the present invention that can only be defined in the claims.

1. A tool including:
a handle including a socket defining a first tunnel, a second tunnel and at least one aperture through which the first tunnel is communicated with the second tunnel;
a bit including a working head formed at an end, a shank formed at an opposite end and a series of recesses defined in the shank, wherein the shank can be inserted in the first tunnel; and
a locking device including at least one ball detent put in the aperture and a latch extending in the second tunnel for pushing the ball detent into one of the recesses in a locking position and defining at least one notch for receiving the ball detent in a releasing position.

2. The tool according to claim 1 wherein the latch includes a button, and the locking device includes a spring compressed between the socket and the button for pushing the latch to the locking position.

3. The tool according to claim 1 wherein the socket defines two apertures, and the locking device includes two ball detents put in the apertures, and the latch defines two notches corresponding to the apertures.

4. The tool according to claim 1 further including a grip formed on the handle.

5. The tool according to claim 1 wherein the first tunnel and the second tunnel extend in parallel with the handle.

6. The tool according to claim 1 wherein the first tunnel and the second tunnel extend perpendicular to the handle.

7. The tool according to claim 8 wherein the bit is a chisel.

8. The tool according to claim 1 wherein the handle includes an additional socket formed thereon in order to receive an additional bit.

9. The tool according to claim 8 wherein the additional bit is a screwdriver.
